(19) United States
(12) Patent Application Publication
(10) Pub. No.: US 2010/0001229 A1
(43) Pub. Date: Jan. 7, 2010

(54) CMP SLURRY FOR SILICON FILM

(75) Inventors: Hiroshi Nakagawa, Hitachi-shi (JP); Toranosuke Ashizawa, Hitachinaka-shi (JP); Takenori Narita, Mito-shi (JP); Masaya Nishiyama, Hitachi-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Chemical Co., Ltd.

(21) Appl. No.: 12/547,802

(22) Filed: Aug. 26, 2009

Related U.S. Application Data
(63) Continuation-in-part of application No. PCT/JP2008/051876, filed on Feb. 5, 2008.

(30) Foreign Application Priority Data
Feb. 27, 2007 (JP) 2007-047008
May 25, 2007 (JP) 2007-139482
Aug. 26, 2008 (JP) 2008-216537

(51) Int. Cl. C09K 13/00

(52) U.S. Cl. 252/79.1

(57) ABSTRACT

The present invention provides a CMP slurry for silicon film, and by using such the slurry, polishing rates and polishing rate ratios of a silicon film, a silicon nitride film and a silicon oxide film required for performing CMP are obtained. In the CMP, a single slurry is used for forming a contact plug in self-alignment manner to decrease costs for producing semiconductor elements and improve yield. The slurry comprises abrasive grains, a cationic surfactant and water and has a pH value of 6.0 to 8.0.

### BACKGROUND OF THE INVENTION

1. Technical Field

The present invention relates to a CMP (chemical mechanical polishing) slurry for silicon film making it possible that in CMP of a silicon film used to form a contact plug, excellent planarization property and wafer in-plane uniformity are obtained through steps the number of which is small.

2. Background Art

In order to heighten the integration degree of semiconductor elements particularly in memory elements such as DRAMs and SRAMs, it is essential for the connection of the source and drain of a MOS transistor with an upper layer interconnection to form a contact plug in a self-alignment manner. FIG. 1 is a schematic view of a cross section of semiconductor elements when contact holes are made in a self-alignment manner and then a polysilicon film, which becomes an electroconductive material, is formed onto the entire wafer surface. In FIG. 1, reference numerals 1, 2 and 3 represent a silicon substrate, a gate insulating film, and a gate structure, respectively. The gate structure 3 has a structure having a gate cap layer 4 of an insulating film on an electroconductive layer. For the electroconductive layer of the gate, a two-layer structure is used which is composed of a metal silicide 9 and a polysilicon 10. For the gate cap layer 4, a silicon nitride film is used. Reference numerals 5 and 6 represent a gate spacer and an etch stopper, respectively. For the gate spacer 5 and the etch stopper 6, a silicon nitride film is used. Reference numeral 7 represents an insulating film. For the insulating film 7, a silicon oxide film, a BPSG film, or the like is used.

The contact holes are made by removing the insulating film 7 by dry etching using a photoresist. Reference numeral 8 represents a polysilicon film which becomes an electroconductive material for contact plugs.

In order to form the contact plugs, it is necessary to remove unnecessary regions of the polysilicon film 8 by CMP. Additionally, in order to prevent a short circuit between the contact holes, it is necessary to remove the gate cap layer 4 partially. However, the gate cap layer 4 needs to be left after the CMP, thus, it is not permissible that the polishing rate of the silicon nitride film constituting the gate cap layer 4 is too large. Accordingly, the ratio between the polishing rate of the polysilicon film and that of the silicon nitride film, that is, the ratio of the polishing rate of the polysilicon film to that of the silicon nitride film is suitably from 5 to 50:1.

Over-polishing for removing the gate cap layer 4 partially and removing the unnecessary regions of the polysilicon film 8 completely is performed in the state that the insulating film 7 is exposed. If the polishing rate of the insulating film 7 is large at this time, the gate cap layer 4 is lost so that the polishing advances up to the electroconductive layer of the gates. As a result, the device yield and the reliability are declined. It is therefore necessary that the polishing rate of the silicon oxide film constituting the insulating film 7 is sufficiently smaller than that of the silicon nitride film constituting the gate cap layer 4 so that the CMP is substantially stopped. However, if the silicon oxide film is not polished at all, the planarization property is reversely damaged. For this reason, the polishing rate of the silicon oxide film is suitably from ⅓ to 1/20 of that of the silicon nitride film. A sectional view of the semiconductor elements after the CMP is illustrated in FIG. 2.

In semiconductor elements as illustrated in FIG. 1, the film thickness of the polysilicon film 8 is from about 100 to 400 nm, and the film thickness of the gate cap layer 4 is from about 10 to 100 nm. In order to carry out CMP by use of a single slurry in such a case, it is appropriate that the polishing rate of the polysilicon film, that of the silicon nitride film and that of the silicon oxide film are from 100 to 300 nm/minute, from 5.0 to 30 nm/minute, and from 0.3 to 3 nm/minute, respectively. The ratio between the polishing rate of the polysilicon film and that of the silicon nitride film, that is, the ratio of the polishing rate of the polysilicon film to that of the silicon nitride film is appropriately from 5 to 50:1, and the ratio between the polishing rate of the silicon nitride and that of the silicon oxide film, that is, the ratio of the polishing rate of the silicon nitride to that of the silicon oxide film is appropriately from 3 to 20:1.

However, the prior art has not provided any slurry capable of giving the above-mentioned polishing rates and polishing rates ratio to a polysilicon film, a silicon nitride film and a silicon oxide film by use of a single slurry. For this reason, a method of performing CMP at two stages by use of two slurries, or some other method has been required. Thus, an increase in costs for the process has been become a serious problem.

The specification of US Patent Application Publication No. 2006/0105569 describes a method of performing CMP by use of a single slurry under CMP conditions that the ratio of the polishing rate of a polysilicon film to that of a silicon nitride film to that of a silicon oxide film becomes from 1:1:1 to 4:1:1. According to this method, however, the ratio between the polishing rate of the silicon nitride film and that of the silicon oxide film, that is, the ratio of the polishing rate of the silicon nitride film to that of the silicon oxide film is as small as 1:1, therefore, it appears that the silicon oxide film does not become a CMP-stopping layer so that the stock polishing (amount) is not easily controlled.

Japanese Patent Application Laid-Open No. 2002-305167 suggests a method using a polishing liquid containing polyethyleneimine and a choline derivative. It is stated that according to this polishing liquid, the polishing rate of a polysilicon film, that of a silicon oxide film and that of a silicon nitride film are 600 nm/minute, 15.2 nm/minute and 33.4 nm/minute, respectively. However, according to this method also, the ratio between the polishing rate of the silicon nitride film and that of the silicon oxide film, that is, the ratio of the polishing rate of the silicon nitride film to that of the silicon oxide film is as small as 2.2:1, therefore, it appears that the silicon oxide film does not become a CMP-stopping layer so that the stock polishing is not easily controlled.

Japanese Patent No. 3457144 discloses a method using a polysilicon-polishing composition containing a basic organic compound. According to this method, the ratio between the polishing rate of a polysilicon film and that of a silicon oxide film is large while the polishing rate of a silicon nitride film is small. For this reason, CMP for forming a contact plug cannot be performed by use of a single slurry.

Japanese Patent No. 3190742 discloses a method using a polishing agent containing phosphoric acid to polish a silicon nitride film. According to this method, the polishing rate of the silicon nitride film is 120 nm/minute, and that of a silicon oxide film is 15 nm/minute. Thus, the ratio of the polishing rate of the silicon oxide film to that of the silicon nitride film is sufficiently small. However, the polishing rate of the polysilicon film is as small as 70 nm/minute. In this case also, therefore, CMP for forming a contact plug cannot be performed by use of a single slurry.

As described above, the prior art has not provided any CMP slurry capable of performing CMP for forming a contact plug, using a single slurry.

An object of the present invention is to provide a CMP slurry for silicon film capable of performing CMP for forming a contact plug in a self-alignment manner, using a single slurry. Another object thereof is to provide a CMP slurry for silicon film capable of decreasing costs for producing semiconductor elements.

### BRIEF SUMMARY OF THE INVENTION

The present invention relates to a CMP slurry for silicon film that solves the above-mentioned problems by use of a cationic surfactant. Another aspect of the invention relates to a CMP slurry for silicon film which contains abrasive grains, a cationic surfactant and water, and exhibits a pH adjusted into an optimal range.

According to the CMP slurry of the invention for silicon film, individual films of a silicon film, a silicon nitride film and a silicon oxide film can be chemically and mechanically polished at appropriate polishing rates and appropriate polishing rate ratios. For this reason, CMP for forming a self-alignment contact plug of a semiconductor element can be attained, using a single slurry. As a result thereof, costs for producing semiconductor elements can be decreased.

### BRIEF DESCRIPTION OF THE DRAWINGS

FIG. 1 is a sectional view illustrating semiconductor elements before CMP; and

FIG. 2 is a sectional view illustrating semiconductor elements after CMP.

### DETAILED DESCRIPTION OF THE INVENTION

A best mode for carrying out the invention will be described in detail hereinafter.

The CMP slurry of the invention for silicon film contains, in an embodiment thereof, abrasive grains, a cationic surfactant and water, and is useful for CMP of a silicon film such as a polysilicon film or an amorphous silicon film.

The abrasive grains used in the invention are not particularly limited as far as the zeta potential of the surface of the grains has a minus sign in the pH range of 6.0 to 8.0. Examples of the abrasive grains used in the invention include silica, alumina, ceria, zirconia, titania, and germania. Of these abrasive grains, silica is preferred. In particular, colloidal silica is preferred since the silica can give abrasive grains small in particle diameter at low costs and cause a reduction of scratches. The zeta potential of the surface of grains and that of any substrate to be polished can each be measured by electrophoresis. Specifically, the zeta potentials can each be measured with a zeta potential measuring device (trade name: Delsa Nano C) manufactured by Beckman Coulter GmbH.

The generation of scratches results in a fall in the yield of LSIs. Thus, for LSIs made finer, a more severe request that scratches should be deceased is made. Accordingly, about the average particle diameter of the abrasive grains, the average particle diameter of secondary particles of the abrasive grains before the CMP slurry is produced is preferably from 5 to 150 nm, more preferably from 10 to 100 nm. The average particle diameter of the secondary particles of the abrasive grains after the CMP slurry is produced is preferably from 5 to 200 nm, more preferably from 10 to 150 nm. If the average particle diameter of the secondary particles of the abrasive grains is out of the ranges before and after the production of the CMP slurry, scratches may easily be generated. The wording “after the CMP slurry is produced” herein refers to a time after about 24 hours elapse from the production of the CMP slurry. The average particle diameter of the secondary particles of the abrasive grains may be measured by dynamic light scattering method. Specifically, the average particle diameter may be measured by means of a submicron particle analyzer N5 manufactured by Beckman Coulter GmbH, or the like.

The concentration of the abrasive grains in the CMP slurry for silicon film is preferably from 0.1 to 10% by weight, more preferably from 0.5 to 5% by weight. If the concentration of the abrasive grains is less than 0.1% by weight, the polishing rate of a silicon film tends to become small. If the concentration is more than 10% by weight, scratches tend to be easily generated.

In the invention, the use of a cationic surfactant can give a high polishing rate of a silicon film, a sufficient ratio of the polishing rate of a silicon nitride film to that of a silicon oxide film, and a sufficient ratio of the polishing rate of the silicon film to that of the silicon nitride film. The pH for obtaining such an advantageous effect is optimally in a neutral range of 6.0 to 8.0. When the pH is in this range, the polishing rate of a silicon nitride film becomes larger than that of a silicon oxide film so that the ratio of the polishing rate of the silicon nitride film to that of the silicon oxide film becomes large. As a result, the polishing selectivity of the silicon nitride film is easily made high. If the pH is larger than 8.0, the polishing rate of the silicon film becomes large but the polishing rate of the silicon nitride film decreases and becomes smaller than that of the silicon oxide film. As a result, an appropriate ratio between the polishing rates is not obtained. If the pH is less than 6.0, the polishing rate of the silicon film becomes small so that the ratio of the polishing rate of the silicon film to that of the silicon nitride film becomes small. Preferred polishing rates of the individual films, and preferred ratios between the polishing rates will be described later.

The cationic surfactant used in the invention has in the molecule thereof a hydrophilic moiety and a hydrophobic moiety. The hydrophilic moiety has a chemical structure which is to be a cation in the CMP slurry. When the CMP slurry of the invention, which contains this cationic surfactant, contacts a film to be polished that contains a silicon film, a silicon oxide film and a silicon nitride film, the zeta potential of the surface of the silicon film, that of the surface of the silicon oxide film, that of the surface of the abrasive grains and that of the surface of the silicon nitride film show preferably a plus sign, a minus sign, a minus sign and a minus sign, respectively. When this cationic surfactant is added to the CMP slurry, the polishing rate of the silicon film, which is polished by the use of the CMP slurry, is improved while the polishing rate of the silicon oxide film is restrained. When the CMP slurry is used in a neutral range of 6.0 to 8.0, the following can be obtained: a sufficient high polishing rate of the silicon film, a sufficient ratio of the polishing rate of the silicon nitride film to that of the silicon oxide film, and a sufficient ratio of the polishing rate of the silicon film to that of the silicon nitride film. The reason why the CMP slurry is used in the neutral range of 6.0 to 8.0 is that an appropriate polishing rate of the silicon nitride film can be obtained.

According to the CMP slurry wherein no cationic surfactant is used, in this pH range, the polishing rate of a silicon nitride film is good while there remains a problem that the polishing rate of a silicon film is small and that of a silicon oxide film is large. About the surface of each of the films to be polished at this time, the silicon film and the silicon nitride film are each charged into a slight minus while the silicon oxide film and the abrasive grains are each charged into an intense minus.

It is desired that the cationic surfactant in the invention has an advantageous effect that when the surfactant is added to the CMP slurry, its hydrophobic moiety is adsorbed onto a silicon film surface and its hydrophilic moiety of a cation causes the sign of the zeta potential of the surface of the silicon film to be reversed from minus to plus. In this way, the abrasive grains are electrically attracted to the silicon film surface so that the polishing rate of the silicon film is improved. The hydrophilic moiety, which has a cation, is adsorbed on the surface of a silicon oxide film so as to be directed inwards. On the other hand, the hydrophobic moiety is directed outwards. The surfactant has an advantageous effect that the silicon oxide film surface is protected so that the polishing rate thereof is restrained. In the meantime, the zeta potential of the surface of the silicon oxide film, that of the abrasive grains, and that of a silicon nitride film are each kept to have a minus sign. Additionally, it is desired that the cationic surfactant is hardly adsorbed on the surface of the silicon nitride film so that the surfactant hardly produces an effect on the zeta potential thereof. Desirably, the amount of a change in the zeta potential is 10 mV or less. If the change amount of the zeta potential is more than 10 mV, the polishing rate of the silicon nitride film, which is good in the neutral range, is also varied so that between the ratio of the polishing rate to the polishing rate of the silicon film, and the ratio of the polishing rate to the polishing rate of the silicon oxide film, balance is deteriorated.

The cationic surfactant used in the invention is not particularly limited as far as the surfactant is a material having, in the molecule thereof, a chemical structure having a hydrophilic moiety and a hydrophobic moiety provided that the hydrophilic moiety becomes a positive ion in the CMP slurry. The surfactant is, for example, an aliphatic amine or a salt thereof, or an aliphatic ammonium salt.

It is preferred to use, as the aliphatic ammonium salt, a compound represented by the following general formula (1):

[R¹N(R²)₃]+X⁻ (1)

wherein R¹ represents a monovalent alkyl group having a main chain having 8 to 18 carbon atoms, and R² each independently represent a monovalent substituent, X⁻ represents a monovalent anion.

The aliphatic ammonium salt represented by the general formula (1) has, as R¹, a long-chain monovalent alkyl group. From the viewpoint of the polishing rate of a silicon film and the storage stability of the slurry, R¹ is preferably a monovalent alkyl group having a main chain having 8 to 18 carbon atoms, more preferably a monovalent alkyl group having a main chain having 10 to 16 carbon atoms. If the number of the carbon atoms in the main chain is too small, the hydrophobicity is decreased so that the amount of additives adsorbed onto a silicon film surface becomes small. As a result, a sufficient polishing rate tend to be not obtained. Thus, the number is preferably 8 or more, more preferably 10 or more. If the number of the carbon atoms is too large, the stability of the CMP slurry tends to get worse. Thus, the number is preferably 18 or less, more preferably 16 or less. In the general formula (1), X is not particularly limited as far as X is a material which becomes a negative ion counter to the cationic moiety. Examples thereof include Cl, Br, NO₃, CH₃COO, and OH. Moreover, the aliphatic ammonium salt represented by the general formula (1) may be a substance which finally becomes a compound represented by the general formula (1) in the CMP slurry. The aliphatic ammonium salt may be obtained by mixing, in water, a substance which becomes [R¹N(R²)₃]+ in the CMP slurry with a substance which becomes X⁻ therein. In the case of using a quaternary ammonium salt having no long-chain alkyl group, such as tetraethylammonium hydroxide, the polishing rate of a silicon film becomes small and the polishing rate of a silicon oxide film unfavorably becomes large, in particular, in a neutral range where the pH is from 6.0 to 8.0.

From the viewpoint of the polishing rate of a silicon film, the ratio of the polishing rate of the silicon film to that of a silicon nitride film, and the ratio of the polishing rate of the silicon nitride film to that of a silicon oxide film, the aliphatic ammonium salt represented by the general formula (1) is more preferably an alkyltrimethylammonium salt represented by the following general formula (2), wherein R² is a methyl group:

[CₙH₂ₙ₊₁N(CH₃)₃]+X⁻ (2)

wherein n is an integer of 8 to 18, X⁻ represents a monovalent anion.

It is also preferred to use, as the aliphatic ammonium salt represented by the general formula (1), a dialkyldimethylammonium salt, wherein one of R²s is equal to R¹ and the others thereof are each a methyl group, or an alkyldimethylbenzylammonium salt, wherein one of R²s is a benzyl group and the others thereof are each a methyl group.

The above-mentioned aliphatic amine or salt thereof is a monoamine, a diamine or a salt thereof. It is preferred to use, as the aliphatic diamine, a compound represented by the following general formula (3):

H₂N—R³—NH₂ (3)

wherein R³ represents a bivalent alkylene group having a main chain having 8 to 18 carbon atoms.

It is also preferred to use, as the aliphatic ammonium salt, a methonium compound represented by the following general formula (4):

((CH₃)₃N—R³—N(CH₃)₃)²⁺2X⁻ (4)

wherein R³ represents a bivalent alkylene group having a main chain having 8 to 18 carbon atoms, X⁻ represents a monovalent anion.

The compound represented by the general formula (3) or (4) gives properties equivalent to those of the compound represented by the general formula (1) while the compound is excellent in that the foaming of the CMP slurry can be decreased. If R³ has a main chain wherein the number of carbon atoms is too small in the general formula (3) or (4), the polishing rate of a silicon film tends to become small. Thus, the number of the carbon atoms is preferably 8 or more, more preferably 10 or more. If the number of the carbon atoms is too large, the stability of the CMP slurry tends to deteriorate. Thus, the number is preferably 18 or less, more preferably 16 or less. In the general formula (4), X is not particularly limited as far as X is a material which becomes a negative ion counter to the cationic moiety. Examples thereof include Cl, Br, NO₃, CH₃COO, and OH.

Specific examples of the cationic surfactant used in the invention include aliphatic ammonium salts such as octyltrimethylammonium bromide, decyltrimethylammonium bromide, lauryltrimethylammonium chloride, myristyltrimethylammonium chloride, cetyltrimethylammonium chloride, and stearyltrimethylammonium bromide; aliphatic amines such as octylamine, decylamine, dodecylamine, 1,8-diaminooctane, 1,10-diaminodecane, 1,12-diaminododecane, 1,14-diaminotetradecane, and 1,16-diaminohexadecane; and methonium compounds such as octamethonium chloride, decamethonium bromide, dodecamethonium bromide, tetradecamethonium chloride, and hexadecamethonium chloride.

The concentration of the cationic surfactant in the CMP slurry for silicon film is preferably from 1 to 1000 ppm, more preferably from 5 to 500 ppm (all (the) ppm's are ppm's in terms of weight). If the concentration of the cationic surfactant is less than 1 ppm, the polishing rate of a silicon film becomes small so that the ratio of the polishing rate of the silicon film to that of a silicon nitride film tends to be declined. If the concentration is more than 1000 ppm, the abrasive grains aggregate so that the storage stability of the CMP slurry tends to deteriorate.

In the invention, the addition of the cationic surfactant makes it possible to attain a high polishing rate of a silicon film and a low polishing rate of a silicon oxide film in a neutral range where the pH is from 6.0 to 8.0, thereby making it possible to make appropriate the ratio of the polishing rate of the silicon film to that of a silicon nitride film and the ratio of the polishing rate of the silicon oxide film to that of the silicon nitride film.

The CMP slurry of the invention for silicon film is a product wherein abrasive grains are dispersed, in a slurry form, in water. The blend amount of the water is the balance relative to the total amount of the above-mentioned individual components.

The pH of the CMP slurry for silicon film is from 6.0 to 8.0, preferably from 6.2 to 7.8. About the CMP slurry of the invention for silicon film, in the range where the pH is from 6.0 to 8.0, the polishing rate of a silicon nitride film is larger as the pH is lower, on the other hand, a change in the polishing rate of a silicon film and a change in the polishing rate of a silicon oxide film are smaller. Therefore, by adjusting the pH, the ratios between the polishing rates of the individual films to be polished can easily be adjusted. If the pH of the CMP slurry for silicon film is less than 6.0, the polishing rate of the silicon film becomes small and that of the silicon nitride film becomes large so that an appropriate polishing rate ratio is not obtained. If the pH is more than 8.0, the polishing rate of the silicon nitride film becomes smaller than that of the silicon oxide film so that an appropriate polishing rate ratio is not obtained. The pH of the CMP slurry may be measured by use of a pH meter.

In order to adjust the pH of the CMP slurry for silicon film, an appropriate acid or alkali may be used as the need arises. The acid is not particularly limited, and may be an inorganic acid such as hydrochloric acid, nitric acid or sulfuric acid, or an organic acid such as oxalic acid, acetic acid or malic acid. The alkali is not particularly limited, and may be ammonia, amine, quaternary ammonium hydroxide, potassium hydroxide or the like. The blend amount of the acid or alkali is appropriately selected, and is usually from 1 to 1000 ppm of the CMP slurry for silicon film.

According to the basic-organic-compound-containing slurry disclosed in Japanese Patent No. 3457144 described above, a high polishing rate of a silicon film and a low polishing rate of a silicon oxide film can be obtained. However, if the pH is less than 6.0, the polishing rate of the silicon film becomes small. If the pH is more than 8, the polishing rate of a silicon nitride film becomes small so that an appropriate polishing rate ratio cannot be obtained.

In the CMP slurry of the invention for silicon film, the addition amount of the cationic surfactant and the acid or alkali used to adjust the pH is very small, thus, the abrasive grains do not aggregate easily so that the slurry is excellent in storage stability.

The CMP slurry of the invention for silicon film is stable even when the components of the CMP slurry are concentrated, thus, a using method in which the slurry is diluted when used is also permissible. The method makes it possible to decrease costs for the CMP slurry further.

In a CMP step for silicon film when a contact plug is formed in a self-alignment manner, it is necessary that in accordance with the thickness of each of a silicon film, a silicon nitride film and a silicon oxide film, polishing conditions are adjusted to give an appropriate polishing rate of each of the films and appropriate ratios between the individual films. However, the polishing rate of each of the films would be varied dependently on various factors such as the quality of the film, the kind of the polishing pad, the kind of the polishing machine, and others. About these factors, adjustable scopes are limited by the polishing pressure, the rotation number of the polishing table, and other polishing conditions. Thus, an appropriate polishing rate of each of the films and appropriate polishing rate ratios are not easily obtained only by optimizing polishing conditions. It is therefore essential to adjust the polishing rates and the polishing rate ratios by effect of the CMP slurry.

In the CMP slurry of the invention for silicon film, the adjustment of the pH makes it possible to adjust only the polishing rate of a silicon nitride film while keeping the polishing rate of a silicon film and that of a silicon oxide film substantially constant. For this reason, the ratios between the polishing rates of the individual films are easily adjusted so that appropriate polishing rates and appropriate polishing rate ratios can easily be attained.

The following will describe an appropriate polishing rate of each film in the case of using the CMP slurry of the invention for silicon film. The polishing rate of a silicon film, R(pSi), is preferably 100 nm/minute or more, more preferably from 100 to 300 nm/minute, even more preferably from 110 to 250 nm/minute. If the polishing rate R(pSi) of the silicon film, is less than 100 nm/minute, the polishing period becomes long so that the productivity lowers. If the rate is more than 300 nm/minute, the planarization property tends to be deteriorated by excessive polishing. The polishing rate of a silicon nitride film, R(SiN), is preferably from 5.0 to 30 nm/minute, more preferably from 5.0 to 20 nm/minute. If the polishing rate R(SiN) of the silicon nitride film is less than 5.0 nm/minute, the polishing period of the silicon nitride film is required to be made long. Thus, the productivity tends to be declined. If the rate is more than 30 nm/minute, the planarization property tends to be deteriorated by excessive polishing. The polishing rate of a silicon oxide film, R(SiO₂), is preferably from 0.3 to 3 nm/minute, more preferably from 0.3 to 2.5 nm/minute. If the polishing rate R(SiO₂) of the silicon film is less than 0.3 nm/minute, a naturally oxidized film on the surface of the silicon film is not easily polished so that the polishing period of the silicon film becomes long. Thus, the productivity tends to be declined. If the rate is more than 3 nm/minute, the planarization property tends to be deteriorated by excessive polishing.

In the case of using the CMP slurry of the invention for silicon film, appropriate polishing rate ratios between the individual films preferably satisfy both of the following formulae (5) and (6) simultaneously:

R(pSi)/R(SiN)>5 (5)

R(SiN)/R(SiO₂)>2 (6)

The formula (5) is a formula representing the ratio of the polishing rate of the silicon film to that of the silicon nitride film. The value of R(pSi)/R(SiN) is preferably more than 5, more preferably more than 5 and 50 or less, in particular preferably 9 or more and 50 or less. If the value of R(pSi)/R(SiN) is 5 or less, the silicon nitride film is excessively polished when over-polishing is performed to remove unnecessary regions of the polysilicon film. Thus, the planarization property tends to be declined. The formula (6) is a formula representing the ratio of the polishing rate of the silicon nitride film to that of the silicon oxide film. The value of R(SiN)/R(SiO₂) is preferably more than 2, more preferably more than 2 and 20 or less, in particular preferably 2.5 or more and 20 or less. If the value of R(SiN)/R(SiO₂) is 2 or less, the planarization property tends to deteriorate.

In a CMP polishing method using the CMP slurry of the invention for silicon film, the CMP slurry of the invention for silicon film is used to polish a substrate on which films to be polished which include a silicon film, a silicon nitride film, and a silicon oxide film. The films to be polished, which are each a subject to be polished, are the silicon film, the silicon nitride film, and the silicon oxide film. These films may each be made of a monolayer or a multilayer. In the invention, the silicon film is a polysilicon film or an amorphous silicon film.

An example of the substrate is a substrate related to the production of a semiconductor device, for example, a substrate wherein an insulating layer is formed on a semiconductor substrate, such as a semiconductor substrate at a stage when circuit elements and a wiring pattern are formed or a semiconductor substrate at a stage when circuit elements are formed.

The polishing of the films to be polished is performed by chemical mechanical polishing. Specifically, in the state that a substrate wherein a surface to be polished is formed is pushed and pressed onto a polishing cloth (pad) of a polishing table, the polishing table and the substrate are moved relatively to each other while the CMP slurry of the invention for silicon film is supplied thereto, thereby polishing the surface to be polished.

For example, in the case of performing polishing by use of a polishing cloth, the polishing machine to be used is an ordinary polishing machine having a holder capable of holding a substrate to be polished, and a table onto which the polishing cloth is to be attached, the table being connected to a motor, the rotation number of which is variable, or to some other member. For example, Mirra manufactured by Applied Materials, Inc. may be used.

The polishing cloth may be an ordinary nonwoven cloth, foamed polyurethane or porous fluorine contained resin, or some other cloth, and is not particularly limited. Conditions for the polishing are not limited. The rotation number of the table is preferably 130 rpm or less for the substrate not to be spun out. The pushing pressure (polishing pressure) of the substrate having the surface to be polished onto the polishing cloth is preferably from 3 to 60 kPa. The pressure is more preferably from 6 to 40 kPa in order that the uniformity of the CMP speed in the surface to be polished and the pattern planarization property can be satisfied.

While the substrate is polished, the CMP slurry for silicon film is continuously supplied to the polishing cloth by means of a pump or the like. The supply amount of the CMP slurry for silicon film is not particularly limited, it is preferred that the surface of the polishing cloth is constantly covered with the CMP slurry for silicon film.

After the polishing is finished, it is preferred to wash the substrate sufficiently in flowing water, use a spin dryer or the like to remove water droplets adhering onto the substrate, and subsequently dry the substrate. In order to perform CMP while making the surface state of the polishing cloth in the same state at all times, it is preferred to perform the step of conditioning the polishing cloth before the polishing. For example, a dresser to which diamond grains are attached is used to condition the polishing cloth by effect of a liquid containing at least water. Subsequently, a CMP polishing step using the invention is carried out. It is preferred to perform a substrate-washing step further.

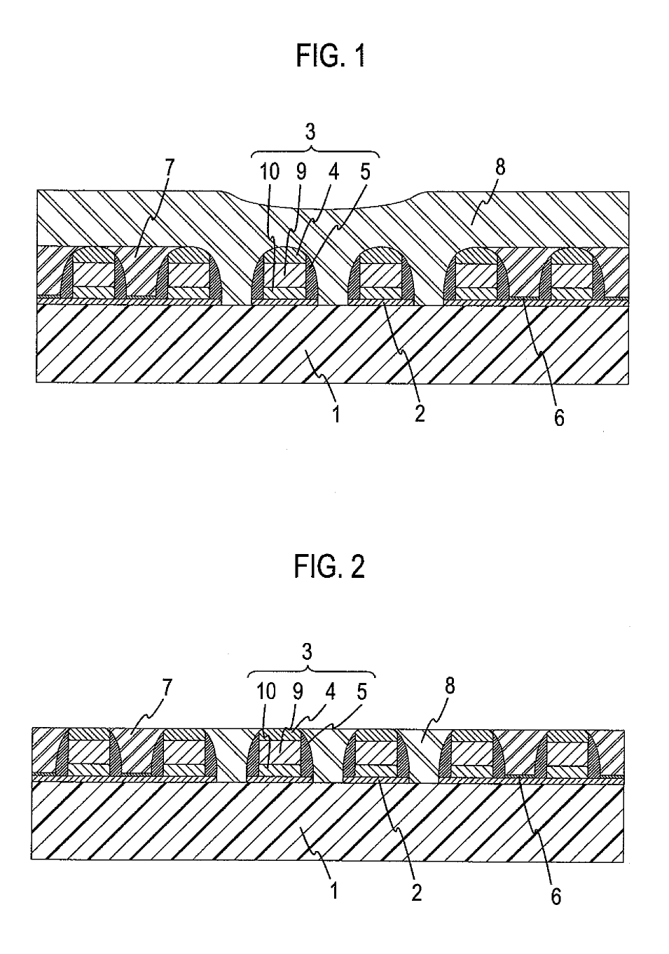

In the case of using the CMP slurry of the invention for silicon film to perform the CMP of semiconductor elements having a cross section as illustrated in FIG. 1, a polysilicon film 8 is polished and subsequently a gate cap layer 4 and an insulating film 7 are made exposed. Thereafter, an appropriate over-polishing is performed. In the CMP using the CMP slurry of the invention for silicon film, appropriate is each of the polishing rate of the polysilicon film 8, the polishing rate of the gate cap layer 4, the polishing rate of insulating film 7, the ratio of the polishing rate of the polysilicon film 8 to that of the polishing rate of the gate cap layer 4, and the ratio of the polishing rate of the gate cap layer 4 to that of the insulating layer 7. Therefore, as illustrated in FIG. 2, the gate cap layer 4 can be partially removed and unnecessary regions of the polysilicon film 8 can be completely removed without making an gate electroconductive layer exposed. Accordingly, by the CMP using a single slurry, a good planarization property and a good in-plane uniformity of the surface to be polished can be obtained. Thus, costs for producing semiconductor elements can be decreased, and the yield and reliability thereof can be improved.

### EXAMPLES

### Examples of the invention will be described hereinafter. The invention is not limited by these examples.

### Examples 1 to 15

In each of Examples 1 to 15, water, colloidal silica, and a cationic surfactant shown in Table 1 or 2 were mixed with each other, and then malic acid was added thereto so as to adjust the pH into a pH shown in Table 1 or 2. In this way, a CMP slurry was produced. The pH was measured with a pH meter (model No. HM-21P, manufactured by DKK-TOA Corp.). Specifically, standard buffer solutions (a phthalic acid salt pH buffer solution, pH: 4.01 (25° C.); a neutral phosphoric acid salt pH buffer solution, pH: 6.86 (25° C.); and a boric acid salt standard solution, pH: 9.18 (25° C.)) were used to make a three-point correction. Thereafter, electrodes were put into the CMP slurry. After 10 minutes or more elapsed and the pH was stabilized, the value thereof was measured.

The concentration of colloidal silica in the CMP slurry was set to 3% by weight. The average particle diameter of secondary particles of the colloidal silica was about 10 nm before the production of the CMP slurry, and was about 20 nm after the production of the slurry. This average particle diameter was hardly changed even after the slurry was allowed to stand still at room temperature for 1 month after the production of the slurry. The average particle diameters were measured, using a submicron particle analyzer N5 (manufactured by Beckman Coulter Inc.).

In Examples 1 to 13, the concentration of the cationic surfactant in the CMP slurry was 100 ppm, in Examples 14 and 15, the concentration was 40 ppm (all (the) ppm's are ppm's in terms of weight). The blend amount of malic acid used to set the pH of each of the CMP slurries to each value shown in Table 1 or 2 was from 5 to 100 ppm in the CMP slurry.

Wafers described below, wherein a polysilicon film, a silicon nitride film and a silicon oxide film were formed, respectively, were each used, and subjected to CMP treatment under polishing conditions described below while each of the CMP slurries of Examples 1 to 15 was dropped onto a pad attached onto a table. Before and after the CMP treatment, the film thickness of each of the wafers was measured with an optical interference film thickness meter. From the difference between the film thicknesses, and the polishing period, the polishing rate was calculated out. The results are shown in Table 1 or 2.

### (Wafers)

The following was used for CMP of the polysilicon film: a wafer obtained by forming a silicon oxide film 100 nm in thickness onto a silicon wafer 8 inches in diameter (φ), and then forming a polysilicon film 500 nm in thickness thereon by CVD (chemical vapor deposition).

The following was used for CMP of the silicon nitride film: a wafer obtained by forming a silicon nitride film 200 nm in thickness onto a silicon wafer 8 inches in diameter (φ) by CVD.

The following was used for CMP of the silicon oxide film: a wafer obtained by forming a silicon oxide film 500 nm in thickness onto a silicon wafer 8 inches in diameter (φ) by plasma CVD.

### (Polishing Conditions)

Polishing machine: Rotary type, table size=600 mm (φ)

Polishing pad: Foamed polyurethane resin

Pad grooves: Concentric grooves

Polishing pressure: 210 hPa

Wafer substrate rotation number: 80 min⁻¹

Polishing table rotation number: 80 min⁻¹

Slurry flow rate: 200 mL/min

Polishing period: 1 minute per film

TABLE 1

| | | Examples | | | | | | |
|---|---|---|---|---|---|---|---|---|
| | | 1 | 2 | 3 | 4 | 5 | 6 | 7 |
| Cationic surfactant | | Octyltrimethyl | Octyltrimethyl | Decyltrimethylammonium | Lauryl | Lauryl | Lauryl | Myristyl |
| | | amonium | amonium | bromide | trimethyl | trimethyl | trimethyl | trimethyl |
| | | bromide | bromide | | ammonium | ammonium | ammonium | ammonium |
| | | | | | chloride | chloride | chloride | chloride |
| pH | | 6.9 | 6.6 | 6.9 | 7.2 | 6.9 | 6.6 | 6.9 |
| Polishing | Polysilicon film | 160 | 150 | 220 | 200 | 200 | 180 | 190 |
| rate | Silicon nitride | 8 | 15 | 12 | 6 | 13 | 20 | 12 |
| (nm/ | film | | | | | | | |
| minute) | Silicon oxide film | 2.0 | 2.5 | 2.0 | 1.3 | 1.4 | 1.6 | 1.2 |
| Polishing | Polysilicon film/ | 20.0 | 10.0 | 18.3 | 33.3 | 15.4 | 9.0 | 15.8 |
| rate ratio | silicon nitride | | | | | | | |
| | film | | | | | | | |
| | Silicon nitride | 4.0 | 6.0 | 6.0 | 4.6 | 9.3 | 12.5 | 10.0 |
| | film/silicon | | | | | | | |
| | oxide film | | | | | | | |

TABLE 2

| | | Examples | | | | | | | |
|---|---|---|---|---|---|---|---|---|---|
| | | 8 | 9 | 10 | 11 | 12 | 13 | 14 | 15 |
| Cationic surfactant | | Cetyltrimethyl | Stearyl | Stearyl | Stearyl | Octylamine | Decylamine | Decamethonium | 1,10- |
| | | ammonium | trimethyl | trimethyl | trimethyl | | | bromide | Diamino |
| | | chloride | ammonium | ammonium | ammonium | | | | dacane |
| | | | chloride | chloride | chloride | | | | |
| pH | | 6.9 | 7.2 | 6.9 | 6.6 | 6.9 | 6.9 | 6.9 | 6.9 |
| Polishing | Polysilicon film | 180 | 170 | 170 | 150 | 110 | 150 | 240 | 170 |
| rate | Silicon nitride | 11 | 6 | 10 | 19 | 5 | 8 | 13 | 7 |
| (nm/ | film | | | | | | | | |
| minute) | Silicon oxide film | 1.0 | 1.5 | 1.8 | 2.0 | 2.0 | 2.0 | 1.8 | 2.0 |
| Polishing | Polysilicon film/ | 16.4 | 28.3 | 17.0 | 7.9 | 22.0 | 18.8 | 18.5 | 24.3 |
| rate ratio | silicon nitride | | | | | | | | |
| | film | | | | | | | | |
| | Silicon nitride | 11.0 | 4.0 | 5.6 | 9.5 | 2.5 | 4.0 | 7.2 | 3.5 |
| | film/silicon | | | | | | | | |
| | oxide film | | | | | | | | |

As shown in Table 1 or 2, in each of Examples 1 to 15, a good value was obtained about each of the polishing rate of the polysilicon film, the polishing rate of the silicon nitride film, the polishing rate of the silicon oxide film, the ratio of the polishing rate of the polysilicon film to that of the silicon nitride film, and the ratio of the polishing rate of the silicon nitride film to that of the silicon oxide film. Moreover, when the pH was made small, the polishing rate of the silicon nitride film was made small. Therefore, it is clear that the polishing rate of the silicon nitride film can be adjusted by adjusting the pH. It is anticipated that when a BPSG film is used instead of the silicon oxide film, the polishing rate is increased to at largest a substantially double value. According to the present examples, however, the CMP slurry of the invention can be applied even to a case where BPSG is used.

### Comparative Example 1

A CMP slurry was produced in the same way as in the above-mentioned examples except that tetramethylammonium hydroxide was used instead of the cationic surfactant and added so as to set the concentration of tetramethylammonium hydroxide in the CMP slurry to 100 ppm, and malic acid was added thereto so as to set the pH to 7.2. The polishing rate of each of the films was measured. The results are shown in Table 3.

### Comparative Example 2

A CMP slurry was produced in the same way as in the above-mentioned examples except that tetramethylammonium hydroxide was used instead of the cationic surfactant and added so as to set the concentration of tetramethylammonium hydroxide in the CMP slurry to 100 ppm, and malic acid was added thereto so as to set the pH to 6.9. The polishing rate of each of the films was measured. The results are shown in Table 3.

### Comparative Example 3

A CMP slurry was produced in the same way as in the above-mentioned examples except that lauryltrimethylamonium chloride was used as a cationic surfactant and added so as to set the concentration of lauryltrimethylamonium chloride in the CMP slurry to 100 ppm, and malic acid was added thereto so as to set the pH to 5.7. The polishing rate of each of the films was measured. The results are shown in Table 3.

### Comparative Example 4

A CMP slurry was produced in the same way as in the above-mentioned examples except that lauryltrimethylamonium chloride was used as a cationic surfactant and added so as to set the concentration of lauryltrimethylamonium chloride in the CMP slurry to 100 ppm, and tetramethylammonium hydroxide was added thereto so as to set the pH to 8.3. The polishing rate of each of the films was measured. The results are shown in Table 3.

TABLE 3

| | | Comparative Examples | | | |
|---|---|---|---|---|---|
| | | 1 | 2 | 3 | 4 |
| Additive | | Tetramethyl | Tetramethyl | Lauryl | Lauryl |
| | | ammonium | ammonium | trimethyl | trimethyl |
| | | hydroxide | hydroxide | amonium | amonium |
| | | | | chloride | chloride |
| pH | | 7.2 | 6.9 | 5.7 | 8.3 |
| Polishing | Polysilicon film | 80 | 70 | 80 | 220 |
| rate | Silicon nitride film | 8.0 | 12.0 | 25.0 | 0.9 |
| (nm/minute) | Silicon oxide film | 6.0 | 6.0 | 2.0 | 1.2 |
| Polishing | Polysilicon film/ | 10.0 | 5.8 | 3.2 | 244.4 |
| rate ratio | silicon nitride film | | | | |
| | Silicon nitride film/ | 1.3 | 2.0 | 12.5 | 0.8 |
| | silicon oxide film | | | | |

As shown in Table 3, in Comparative Examples 1 and 2, wherein no cationic surfactant was used, the polishing rate of the polysilicon film was smaller and the polishing rate of the silicon oxide film was larger than in Examples 1 to 15. From these results, it is clear that CMP slurries using no cationic surfactant can neither give an appropriate polishing rate of each of the films nor appropriate ratios between the polishing rates. In Comparative Example 3, wherein the pH of the CMP was low, the polishing rate of the polysilicon film was small and the ratio of the polishing rate of the polysilicon film to that of the silicon nitride film was insufficient. In Comparative Example 4, wherein the pH of the CMP slurry was high, the polishing rate of the silicon nitride film was unfavorably smaller than that of the silicon oxide film. From these results, it can be understood that if the pH of CMP slurries is less than 6.0 or more than 8.0, the slurries can neither give appropriate polishing rates of the three films nor appropriate ratios between the polishing rates.

It is preferable that the cationic surfactant causes the sign of the zeta potential of the surface of the silicon film to be reversed from minus to plus. Thus, pH of various CMP slurries including lauryltrimethylammonium chloride used in Examples 4 and 5 and the above-mentioned zeta potentials ware measured.

### Example 16

A CMP slurry was produced in the same way as in the above-mentioned examples 1-15 except that the concentration of lauryltrimethylammonium was 400 ppm and malic acid was added thereto so as to set the pH to 7.0.

### Comparative Example 5

A CMP slurry was produced in the same way as in the above-mentioned Examples 1-15 except that lauryltrimethylammonium was not added and malic acid was added thereto so as to set the pH to 7.2.

The average particle diameter of secondary particles of the colloidal silica in Example 16 and Comparative Example 5 respectively and change thereof according to time passage were same as those of Examples 1-15.

The polishing rate of each of the films using the CMP slurries of Example 16 and Comparative Example 5 was measured respectively in the same way as Examples 1-15. The results are shown in Tables 4 and 5.

The zeta potential of the surface of the grains of each of the CMP slurries of Example 16 Comparative Example 5 and Examples 4 to 5 and Comparative Examples 3 to 4 was measured with a zeta potential measuring device (trade name: Delsa Nano C) manufactured by Beckman Coulter GmbH. The results are shown in Tables 4 and 5.

For the measurement of the zeta potential of the surface of each of substrates to be polished, each evaluating slurry (slurry for evaluation) was prepared as follows. The slurry was used to measure the zeta potential with the zeta potential measuring device (trade name: Delsa Nano C) manufactured by Beckman Coulter GmbH. Specifically, prepared was first a slurry wherein from each of the CMP slurries of Examples 4, 5, 16 and Comparative Examples 3 to 5, the abrasive grains were removed. To this slurry were added standard grains (item number: A54496) manufactured by Otsuka Electronics Co., Ltd., for solid surface cell, in an amount of 0.5%. The resultant was used as each evaluating slurry. Each of the evaluating substrates was cut into a piece having a size of 1.2 cm×2.5 cm. A solid-surface-measuring cell was used to measure the zeta potential of each of the substrates. The results are shown in Tables 4 and 5.

TABLE 4

| | | Examples | | |
|---|---|---|---|---|
| | | 4 | 5 | 16 |
| Cationic surfactant | | Lauryltrimethyl | Lauryltrimethyl | Lauryltrimethyl |
| | | ammonium chloride | ammonium chloride | ammonium chloride |
| Concentration of cationic surfactant (ppm) | | 100 | 100 | 400 |
| pH | | 7.2 | 6.9 | 7.0 |
| Polishing | Polysilicon film | 200 | 200 | 230 |
| rate | Silicon nitride film | 6 | 13 | 12 |
| (nm/minute) | Silicon oxide film | 1.3 | 1.4 | 1.1 |
| Polishing rate ratio | Polysilicon film/silicon nitride film | 33.3 | 15.4 | 19.2 |
| | Silicon nitride film/silicon oxide film | 4.6 | 9.3 | 10.9 |
| Zeta | Abrasive grains | −22 | −18 | −18 |
| potential | Polysilicon film | 16 | 15 | 28 |
| (mV) | Silicon nitride film | −4 | −5 | −7 |
| | Silicon oxide film | −28 | −24 | −12 |

TABLE 5

| | | Comparative Examples | | |
|---|---|---|---|---|
| | | 3 | 4 | 5 |
| Additive | | Lauryltrimethyl | Lauryltrimethyl | — |
| | | ammonium chloride | ammonium chloride | |
| Concentration of additive (ppm) | | 100 | 100 | — |
| pH | | 5.7 | 8.3 | 7.2 |
| Polishing | Polysilicon film | 80 | 220 | 85 |
| rate | Silicon nitride film | 25.0 | 0.9 | 7.0 |
| (nm/minute) | Silicon oxide film | 2.0 | 1.2 | 6.0 |
| Polishing rate ratio | Polysilicon film/silicon nitride film | 3.2 | 244.4 | 12.1 |
| | Silicon nitride film/silicon oxide film | 12.5 | 0.8 | 1.2 |
| Zeta | Abrasive grains | −18 | −18 | −35 |
| potential | Polysilicon film | 15 | 28 | −19 |
| (mV) | Silicon nitride film | −5 | −7 | −8 |
| | Silicon oxide film | −24.0 | −12 | −52 |

As Shown in Tables 4 and 5, it is understood from comparison between Examples 4, 5,16 and Comparative Example 5 that by the addition of lauryltrimethylammonium chloride, the zeta potential of the polysilicon film surface in the slurry was reversed from minus in Comparative Example 5 to plus while the sign of each of the silicon oxide film surface, the abrasive grain surface and the silicon nitride film surface was kept without being changed. Moreover, the surface potential of the silicon nitride film was hardly changed. In each of Examples 4, 5, 16, the polishing rate of the polysilicon film became largely better and the polishing rate of the silicon oxide film became lower than in Comparative Example 5.

1. A CMP slurry for silicon film, comprising abrasive grains, a cationic surfactant and water, and having pH of 6.0 to 8.0.

2. The CMP slurry for silicon film according to claim 1, wherein the cationic surfactant is one or more selected from aliphatic amines or salts thereof, and aliphatic ammonium salts.

3. The CMP slurry for silicon film according to claim 1, wherein the cationic surfactant is an aliphatic ammonium salt represented by the following general formula (1):
[R¹N(R²)₃]+X⁻ (1)
wherein R¹ represents a monovalent alkyl group having a main chain having 8 to 18 carbon atoms, and R² each independently represent a monovalent substituent, X⁻ represents a monovalent anion.

4. The CMP slurry for silicon film according to claim 1, wherein the cationic surfactant is an aliphatic ammonium salt represented by the following general formula (2):
[CₙH₂₊₁N(CH₃)₃]+X⁻ (2)
wherein n is an integer of 8 to 18, X⁻ represents a monovalent anion.

5. The CMP slurry for silicon film according to claim 1, wherein the cationic surfactant is one or more aliphatic ammonium salts selected from alkyltrimethylammonium salt, dialkyldimethylammonium salt, and alkyldimethylbenzylammonium salt.

6. The CMP slurry for silicon film according to claim 1, wherein the cationic surfactant is an aliphatic amine represented by the following general formula (3):
H₂N—R³—NH₂ (3)
wherein R³ represents a bivalentalkylene group having a main chain having 8 to 18 carbon atoms.

7. The CMP slurry for silicon film according to claim 1, wherein the cationic surfactant is an aliphatic ammonium salt represented by the general formula (4):
((CH₃)₃N—R³—N(CH₃)₃)²⁺2X⁻ (4)
wherein R³ represents a bivalent alkylene group having a main chain having 8 to 18 carbon atoms, X⁻ represents a monovalent anion.

8. The CMP slurry for silicon film according to claim 1, wherein the zeta potential of the surface of the abrasive grains has a minus sign, and
when the CMP slurry contacts a silicon film, a silicon oxide film and a silicon nitride film, respectively, the zeta potential of the surface of the silicon film, that of the surface of the silicon oxide film and that of the surface of the silicon nitride film show a plus sign, a minus sign, and a minus sign, respectively.

9. The CMP slurry for silicon film according to claim 8, wherein the amount of a change in the zeta potential of the silicon nitride film surface is 10 mV or less on the basis of the addition of the cationic surfactant to the slurry.

10. The CMP slurry for silicon film according to claim 1, wherein the polishing rate of a silicon film, R(pSi), is 100 nm/minute or more, the polishing rate of a silicon nitride film, R(SiN), is from 5.0 to 30 nm/minute, and the polishing rate of a silicon oxide film, R(SiO₂), is from 0.3 to 3 nm/minute.

11. The CMP slurry for silicon film according to claim 1, wherein the ratio of the polishing rate of a silicon film to that of a silicon nitride film, R(pSi)/R(SiN), is more than 5, and further the ratio of the polishing rate of the silicon nitride film to that of a silicon oxide film, R(SiN)/R(SiO₂), is more than 2.
